(19) United States
(12) Patent Application Publication
(10) Pub. No.: US 2008/0082236 A1
(43) Pub. Date: Apr. 3, 2008

(54) Airbag apparatus

(75) Inventor: Michihisa Asaoka, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/905,386

(22) Filed: Sep. 28, 2007

(30) Foreign Application Priority Data
Sep. 29, 2006 (JP) 2006-267829

(51) Int. Cl. B60R 21/26; B60R 21/203

(52) U.S. Cl. 701/45; 280/736

(57) ABSTRACT

The airbag apparatus includes an inflator supplying inflation gas to an airbag under control of a control device. The inflator has two modes of operation; a rapid discharge mode where the inflator discharges a great amount of inflation gas and a slow discharge mode where the amount of substance of inflation gas supplied into the airbag per unit time is less than in the rapid discharge mode. The airbag apparatus includes means for reducing the resistance which the airbag encounters upon protruding from the housing under control of the control device. The means assist the airbag with protrusion from the housing when the inflator operates in the slow discharge mode.

The present application claims priority from Japanese Patent Application No. 2006-267829 of Asaoka, filed on Sep. 29, 2006, the disclosure of which is hereby incorporated into the present application by reference.

### BACKGROUND OF THE INVENTION

1. Field of the Invention

The present invention relates to an airbag apparatus including an airbag housed in a housing in a folded state, an inflator for supplying the airbag with inflation gas, and an airbag cover for covering the housing.

2. Description of Related Art

JP 2004-507402 discloses an airbag apparatus including an airbag, an inflator and an airbag cover. The airbag cover includes a door openable when the airbag fed with inflation gas from the inflator inflates and pushes the door. The airbag projects from an opening provided by the opening of the door, and deploys. Conventionally, the door is integrally formed with the airbag cover for better appearance while having a breakable portion around the door which is adapted to break when pushed by the airbag so the door opens.

With the above structure, the airbag has to have a high internal pressure from the initial stage of inflation in order to overcome a high resistance and break the breakable portion of the airbag cover so the door opens. However, if the airbag has a high internal pressure in the initial stage of inflation when it projects from the housing, it may apply an undue load to a vehicle occupant.

### SUMMARY OF THE INVENTION

An object of the present invention is to provide an airbag apparatus in which the internal pressure of an airbag does not increase excessively in the initial stage of airbag inflation while securing a smooth protrusion of the airbag from an airbag housing.

The object of the present invention is achieved by an airbag apparatus having the following structure:

The airbag apparatus includes an airbag folded and housed in a housing, an inflator for supplying inflation gas to the airbag, an airbag cover disposed to cover the housing, and resistance reduction means. The inflator is operable under control of a control device and has two modes of operation; a rapid discharge mode where the inflator discharges a great amount of inflation gas and a slow discharge mode where the amount of substance of inflation gas supplied into the airbag per unit time is less than in the rapid discharge mode. The resistance reduction means is operable under control of the control device for reducing a resistance which the airbag encounters upon protruding from the housing to assist the airbag with protrusion from the housing when the inflator operates in the slow discharge mode.

In the airbag apparatus according to the present invention, the inflator has slow and rapid discharge modes as described above. Accordingly, if the inflator operates in the slow discharge mode, inflation gas is gradually fed into the airbag to unfurl the airbag. This mode prevents the inflator from feeding a great amount of inflation gas rapidly into the airbag in the initial stage of operation of the inflator, thereby preventing an excessive increase of internal pressure of the airbag in the initial stage of airbag inflation.

Further, with the above-described resistance reduction means, if the means is activated to reduce the resistance which the airbag would experience upon protrusion from the housing during the slow discharge mode of the inflator, the airbag is allowed to protrude from the housing without experiencing a great resistance. That is, even when the airbag is fed with inflation gas gently in the slow discharge mode in the initial stage of airbag inflation, the airbag is capable of protruding from the housing smoothly without experiencing a great resistance, so that the airbag smoothly deploys with suppressed internal pressure.

Therefore, in the airbag apparatus of the present invention, the internal pressure of the airbag is suppressed in the initial stage of inflation while securing a smooth protrusion of the airbag from the airbag housing.

Specifically, the resistance reduction means may be comprised of opening forming means which forms an opening allowing the airbag to protrude therefrom by moving at least part of the airbag cover.

Alternatively, the resistance reduction means may be comprised of decoupling means to decouple the airbag cover from the housing such that the airbag cover is allowed to open pushed by the airbag in process of inflation.

In the airbag apparatus of the present invention, it is desired that the control device is electrically connected with a pre-crash sensor and a crash sensor, and that the control device activates the resistance reduction means together with the inflator in the slow discharge mode when sensing an unavoidable crash by a signal fed from the pre-crash sensor, and activates the inflator in the rapid discharge mode when sensing an actual impact by a signal fed from the crash sensor.

With this structure, before an actual crash, the airbag unfurls from the folded state and protrudes from the housing area for further gradual inflation by inflation gas fed from the inflator in the slow discharge mode in a state where the resistance reduction means is in operation. Then the airbag inflates to the full upon the detection of an actual crash by inflation gas supplied from the inflator in the rapid discharge mode where the amount of substance of supply of inflation gas per unit time is greater than that in the slow discharge mode. That is, since the inflation gas is supplied to the airbag from the inflator operating in the slow discharge mode ahead of the detection of an actual impact, the internal pressure of the airbag is prevented from rising rapidly during the time period from the detection of an actual crash to the completion of inflation in comparison with an instance where a conventional inflator is used to inflate the airbag after a detection of an actual crash. Accordingly, when the airbag apparatus is directed to protect a vehicle occupant during the time period from the detection of a crash to the full inflation of the airbag, the airbag does not apply an undue pressure to the occupant, and moreover, since the airbag already has an internal pressure of a certain level at the time of the crash, it protects the occupant smoothly with an adequate cushioning property. Of course, in the airbag apparatus of the present invention, too, the airbag is kept fully inflated for a certain time period after the completion of inflation in a similar manner to an instance where an airbag starts to be inflated after a detection of a crash.

The airbag cover of above airbag apparatus desirably includes a door openable when pushed by the airbag in process of inflation for forming an opening allowing the airbag to protrude therefrom when the inflator operates in the rapid discharge mode upon a crash and the resistance reduction means is inactive.

With this structure, even in the event that the control device failed to predict a potential crash by the pre-crash sensor, if the door is pushed and opened by the airbag inflating with inflation gas fed in the rapid discharge mode after an actual impact, the airbag deploys quickly from the opening provided by the opening of the door.

It will also be appreciated that the inflator of the airbag apparatus of the present invention includes a gas generating chamber filled up with a pressurized gas, which gas is a compressed gas for inflating the airbag, a first gas supply region for supplying inflation gas in the slow discharge mode and a second gas supply region for supplying inflation gas in the rapid discharge mode. The first gas supply region includes a first gas channel communicated with the gas generating chamber and a valve mechanism for opening and closing the first gas channel. The second gas supply region includes a second gas channel communicated with the gas generating chamber, a sealing member sealing off the second gas channel, and a squib disposed inside the gas generating chamber for ignition to generate a gas. Arise of an internal pressure of the gas generating chamber upon ignition of the squib helps to break the sealing member to open.

With this structure, the inflator is constructed with only one gas generating chamber, which simplifies the structure of the inflator.

### BRIEF DESCRIPTION OF DRAWINGS

FIG. 1 is a schematic sectional view of a steering wheel equipped with an airbag apparatus according to the first embodiment of the present invention;

FIG. 2 is a partial enlarged sectional view of the steering wheel of FIG. 1;

FIG. 3 is a schematic perspective view of an airbag of the airbag apparatus inflated by itself;

FIGS. 4A and 4B are schematic sectional views of an inflator of the airbag apparatus showing a first gas supply region and a second gas supply region in operation, respsctively;

FIGS. 5A, 5B and 5C are schematic sectional views of the airbag apparatus in operation, particularly illustrating the way a pad is pushed up by a push-up mechanism for allowing the airbag to deploy in order;

FIGS. 6A, 6B and 6C are schematic sectional views of the airbag apparatus in operation, particularly illustrating the way doors of the pad are pushed open by the airbag for allowing airbag deployment in order;

FIG. 7 is a graph showing the change of the internal pressure of the airbag upon operation of the inflator against time;

FIG. 8 is a sectional view of an airbag apparatus for a front passenger's seat according to the second embodiment of the present invention taken along the longitudinal direction;

FIG. 9 is a sectional view of the airbag apparatus of FIG. 8 taken along the lateral direction;

FIG. 10 is a schematic section of an inflator body of the airbag apparatus of FIG. 8;

FIG. 11 is a schematic enlarged sectional view of the vicinity of a first gas supply region of the inflator body of FIG. 10;

FIG. 12 is a schematic enlarged sectional view showing an electromagnetic valve of the first gas supply region in operation;

FIG. 13 is a schematic enlarged sectional view of the vicinity of a second gas supply region of the inflator body of FIG. 10 where a squib is ignited;

FIG. 14 is a schematic sectional view of the airbag apparatus of the second embodiment in operation, particularly showing the way an airbag cover and a case are disengaged from each other by a decoupling mechanism for allowing airbag deployment; and

FIG. 15 is a schematic sectional view of the airbag apparatus in contrast with FIG. 14 showing a door of the airbag cover being pushed open by the airbag for allowing airbag deployment.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

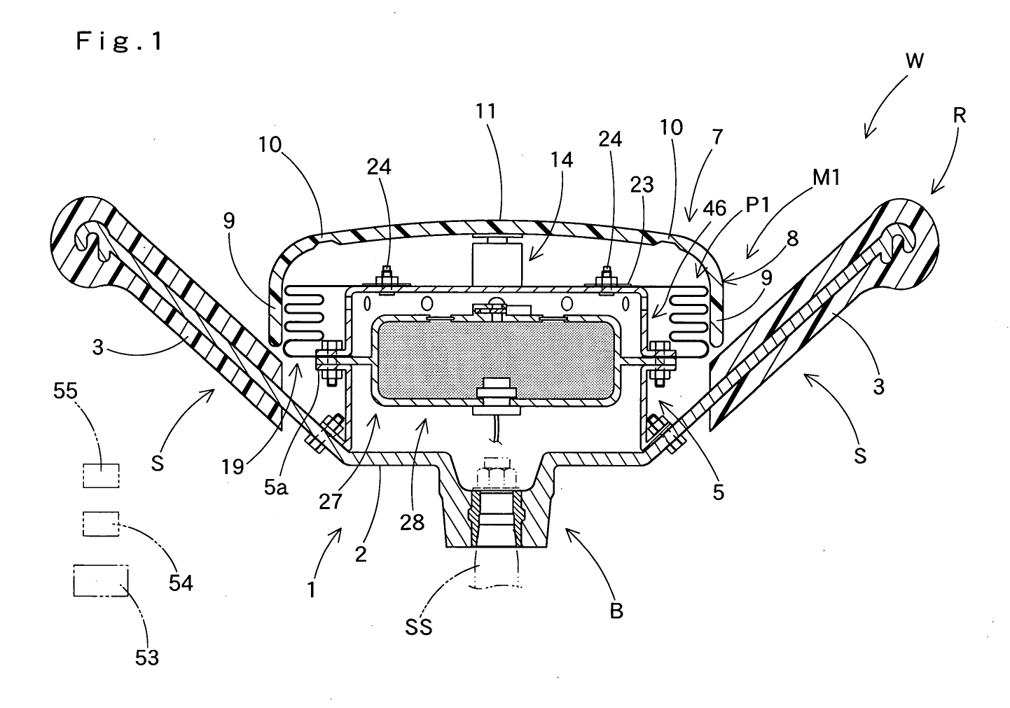

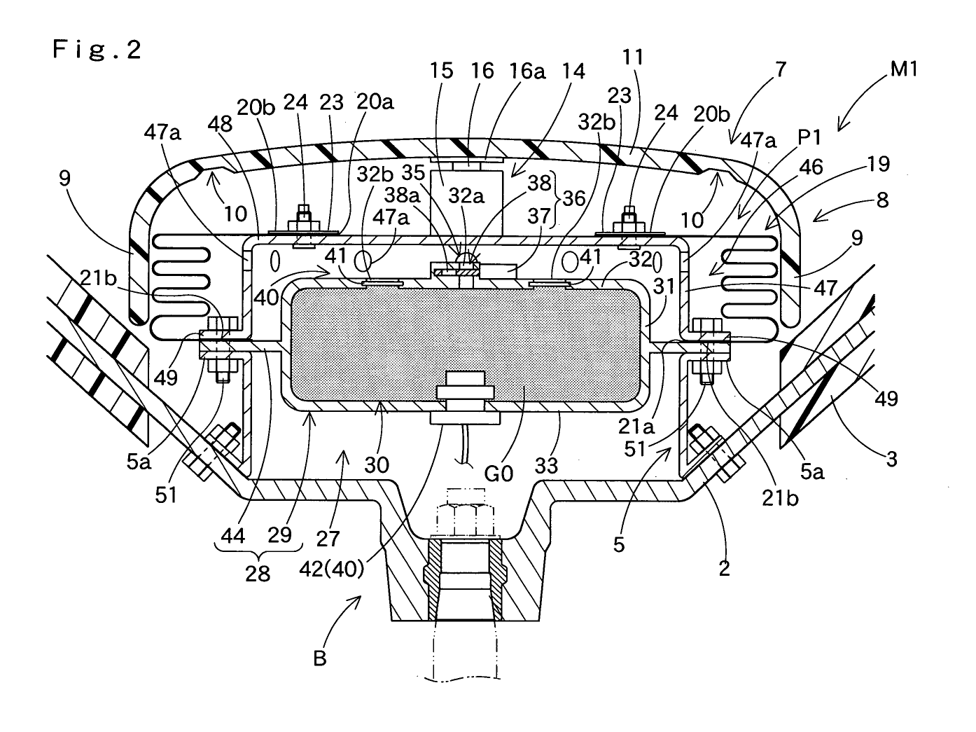

FIGS. 1 and 2 illustrate an airbag apparatus M1 for a steering wheel according to the first embodiment of the present invention.

Unless otherwise specified, front/rear, up/down, and left/right directions in the first embodiment are based on a steering wheel W mounted on a vehicle and steered straight ahead. Specifically, the up/down is intended to refer to the up/down direction extending along the axial direction of a steering shaft SS (refer to phantom lines in FIG. 1) on which the steering wheel W is mounted. The front/rear is intended to refer to the vehicle's front/rear direction running orthogonal to the axial direction of the steering shaft SS, and the left/right is intended to refer to vehicle's lateral direction running orthogonal to the axial direction of the steering shaft SS.

As shown in FIGS. 1 and 2, the airbag apparatus M1 is mounted on top of a boss B located at the center of the steering wheel W. The steering wheel W includes a ring R, the boss B and more than one spokes S. The ring R is for holding at the time of steering operation. The boss Bis disposed at the center of the steering wheel W and is joined with the steering shaft SS. The spokes S interconnect the boss B and the ring R. The steering wheel W includes, as components, an airbag device M1 and a steering wheel body 1.

The wheel body 1 includes a wheel core 2 fabricated of aluminum alloy or the like and having such a configuration that the ring R, the boss B and the spokes S are interconnected, and a cladding layer 3 made from synthetic resin for cladding the core 2 at the ring R and regions of the spokes S in the vicinity of the ring R.

Referring to FIG. 1, the airbag apparatus M1 includes a folded airbag 19, an inflator 27 for supplying inflation gas to the airbag 19, a pad or an airbag cover 7 covering the folded-up airbag 19, and a push-up mechanism 14 acting as means to form an opening so as to reduce the resistance which the airbag 19 would experience upon protruding from an airbag housing. The airbag 19 of the first embodiment is housed in a folded state in a space above and at sides of a later-described diffuser 46 of the inflator 27 between the diffuser 46 and the pad 7. This space between the diffuser 46 and the pad 7 acts as a housing area P1 accommodating the folded airbag 19. In the first embodiment, operations of the inflator 27 and the push-up mechanism 14 are under control of a control device 53.

As shown in FIG. 1, the control device 53 is electrically connected with a pre-crash sensor 54 such as a millimeter wave radar, which measures the relative speed and distance of an impact object, and a crash sensor 55 such as an acceleration sensor measuring the deceleration of vehicle upon an actual impact. The control device 53 operates the inflator 27 and the push-up mechanism 14 in response to electric signals fed from these sensors 54 and 55.

The inflator 27 and the airbag 19 are coupled to the location of the boss B of the wheel core 2 by a bracket 5. The bracket 5 has a generally circular cylindrical contour open at top and bottom so a later-described body 29 of the inflator 27 is put therethrough. The bracket 5 is bolt fixed to the wheel core 2 at the bottom, and includes a flange 5a on top to which a later-described flange 44 of the inflator 27 is attached.

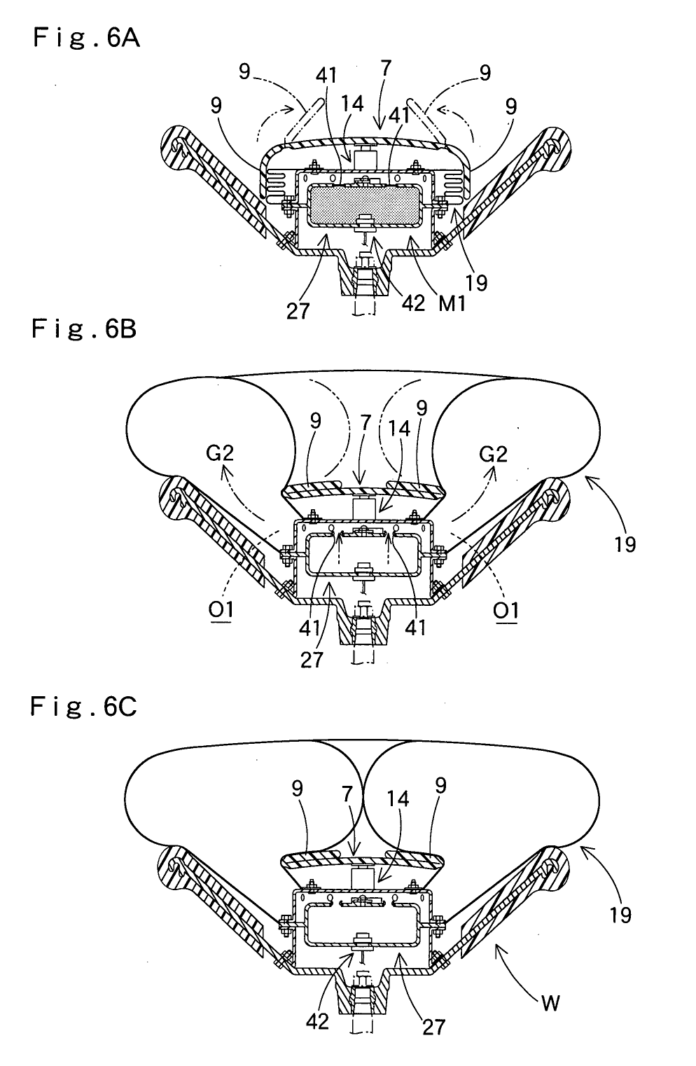

The pad or the airbag cover 7 is made from synthetic resin such as thermo-plastic elastomer of olef in, styrene or the like. As shown in FIG. 1, the pad 7 includes a generally circular cylindrical side wall 8 covering the folded airbag 19 from a side, and a generally discoid ceiling wall 11 covering the airbag 19 from above. In the foregoing embodiment, a central area of the ceiling wall 11 of the pad 7 is connected to a central area of the diffuser 46 by the push-up mechanism 14. At location of the side wall 8 of the pad 7 are doors 9 openable by the airbag 19 inflated with inflation gas G2 fed from a later-described second gas supply region 40 of the inflator 27 when the push-up mechanism 14 is inactive, as shown in FIG. 6. In this embodiment, the doors 9 are such that the side wall 8 of the pad 7 is split up into a plurality, e.g., four to eight, of doors along the circumferential direction of the steering shaft SS. Each of the doors 9 has unillustrated frangible portions therearound and disposed along the circumferential direction of the steering shaft SS and a hinge portion 10 at its top bordering the ceiling wall 11 about which hinge portion 10 the door 9 open.

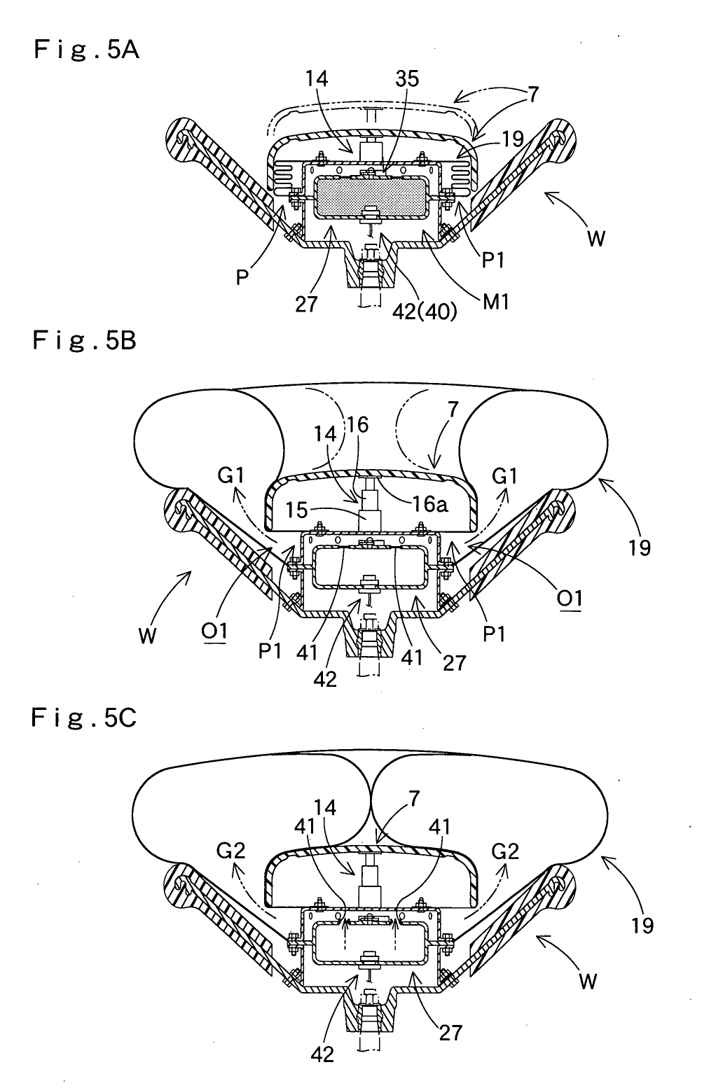

The push-up mechanism 14 acting as the opening forming means and further as the resistance reduction means includes a micro gas generator 15 acting as an actuator and a multistage piston rod 16 pushed up by the micro gas generator 15. At the top of the piston rod 16 is a generally discoid main body 16a for lifting the whole pad 7 upon activation of the mechanism 14. Lifting of the pad 7 provides a generally circular cylindrical opening O1 below the lifted side wall 8 of the pad 7 and all around the airbag 19 housed in a folded state as shown in FIG. 5 and from which opening O1 the airbag 19 protrudes and deploys. In this embodiment, the push-up mechanism 14 activates the micro gas generator 15 in response to a signal from the control device 53 when the control device 53 detects that an impact is unavoidable before an impact by a signal sent from the pre-crash sensor 54 and generally simultaneously with the operation of a later-described first gas supply region 35 of the inflator 27.

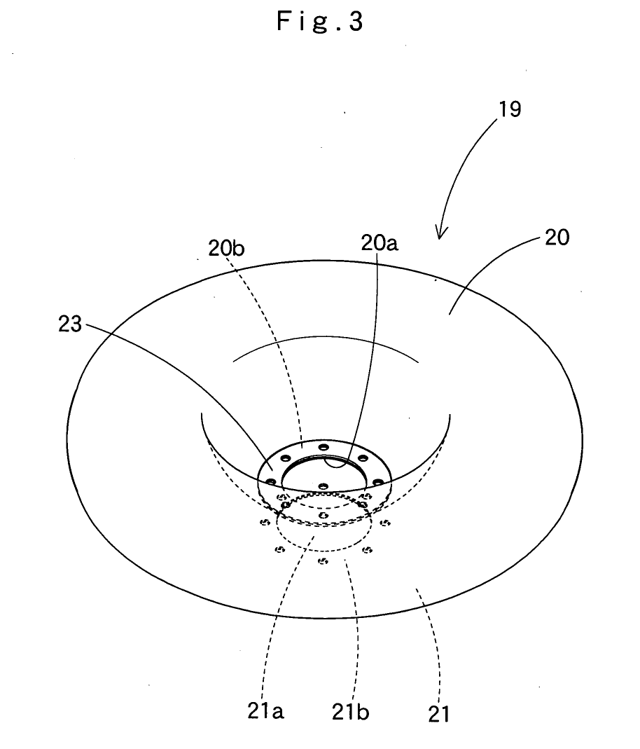

The airbag 19 is formed of a flexible woven fabric of polyester, polyamide or the like into a bag shape. At full inflation, the airbag 19 is configured into a generally ring profile as shown in FIG. 3, and covers generally whole top faces of the ring R and pad 7 as shown in FIGS. 5C and 6C. As shown in FIG. 3, the airbag 19 of this embodiment includes an occupant side wall 20 and a vehicle body side wall 21 each of which having a generally circular shape. Generally circular apertures 20a and 21a are formed at the center of each of the occupant side wall 20 and vehicle body side wall 21, and whole peripheral areas 20b and 21b of the apertures 20a and 21a are attached to the inflator 27. More specifically, as shown in FIG. 2, the peripheral area 21b of the aperture 21a on the vehicle body side wall 21 is disposed between the flange 44 of the inflator body 28 and a flange 49 of the diffuser 46 and bolt 51 fixed to the bracket 5 together with the flanges 44 and 49, thereby attaching the peripheral area 21b to the inflator 27. The peripheral area 20b of the aperture 20a on the occupant side wall 20 is attached to a ceiling wall 48 of the diffuser 46 utilizing a retainer 23 shown in FIG. 2. It is disposed between the ceiling wall 48 and the retainer 23, and bolt 24 fixed to the ceiling wall 48 together with the retainer 23, thereby attaching the peripheral are 20b to the inflator 27. As shown in FIGS. 2, 5 and 6, the airbag 19 admits inflation gas G1 and G2 flowing out of the diffuser 46 from an area between the peripheral areas 20b and 21b secured to the inflator 27.

Referring to FIGS. 1 and 2, the inflator 27 includes an inflator body 28 having a discoid contour and a diffuser 46 disposed over the inflator body 28. The inflator 27 has two modes of operation: the rapid discharge mode where it discharges a great amount of inflation gas G2 and the slow discharge mode where the amount of substance of inflation gas G1 supplied into the airbag 19 per unit time is less than in the rapid discharge mode.

The inflator body 28 includes a generally columnar main body 29 and a flange 44 for attachment of the inflator body 28 to the bracket 5. The flange 44 projects outwardly from the vicinity of vertical center of the main body 29 in a generally annular contour. The main body 29 includes a gas generating chamber 30 filled up with a pressurized gas G0, which is a compressed gas for inflating the airbag, and two gas supply regions supplying the airbag 19 with inflation gas: a first gas supply region 35 supplying inflation gas G1 in the slow discharge mode and a second gas supply region 40 supplying inflation gas G2 in the rapid discharge mode.

As shown in FIG. 2, the gas generating chamber 30 is defined by a circumferential wall 31 having a generally cylindrical shape and a generally circular top wall 32 and bottom wall 33 disposed in such a manner as to close off opposite axial ends of the circumferential wall 31. The chamber 30 contains pressurized gas G0 such as nitrogen gas, helium gas, argon gas, or mixed gas of those gasses. The top wall 32 is provided with an orifice 32a acting as a first gas channel of the first gas supply region 35 and an orifice 32b acting as a second gas channel of the second gas supply region 40. The orifice 32b is sealed off by a sealing member 41. In this specific embodiment, the orifice 32b is formed in plurality around the orifice 32a and a total opening area of the orifices 32b is greater than that of the orifice 32a.

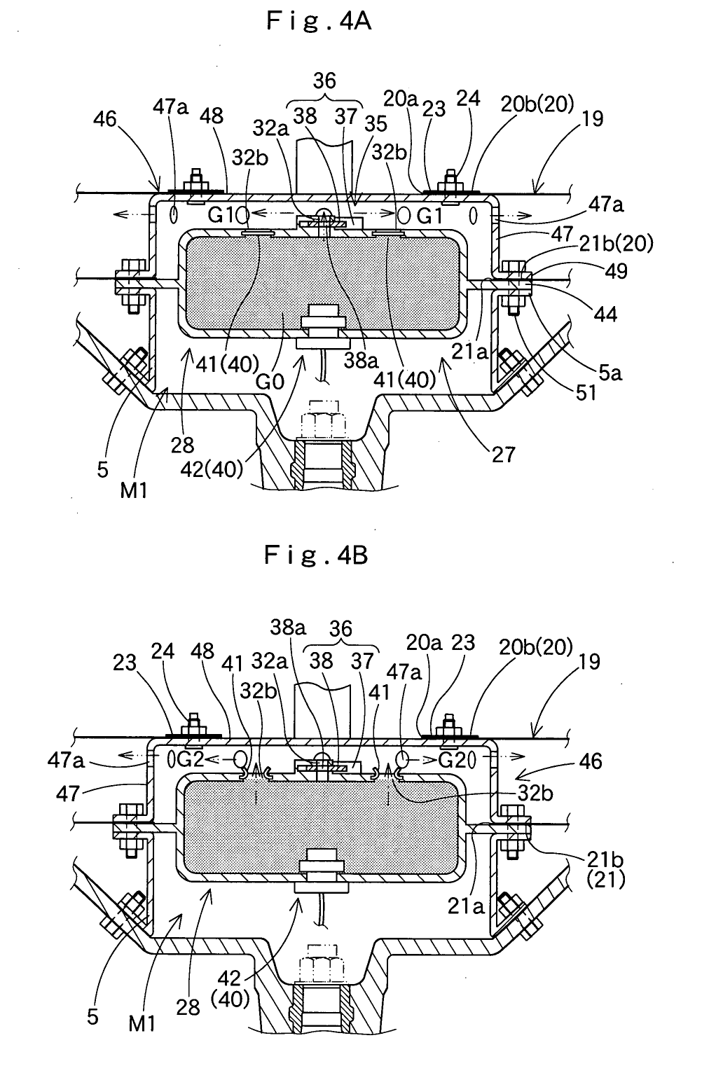

The first gas supply region 35 is disposed at the vicinity of the center of the top wall 32, and is comprised of the orifice 32a communicated with the gas generating chamber 30 and an electromagnetic valve 36 used to open or close the orifice 32a. As shown in FIGS. 2, 4-6, the electromagnetic valve 36 includes a solenoid 37 and a valve body 38. A through hole 38a is formed through a distal area of the valve body 38. When the solenoid 37 is de-energized, the valve body 38 closes off the orifice 32a at its root side region as shown in FIG. 2, whereas it moves toward the solenoid 37 when energized so the through hole 38a is communicated with the orifice 32a as shown in FIGS. 4A and 4B, thereby opening the orifice 32a. The solenoid 37 is electrically connected with the control device 53 and is designed to operate in advance of the operation of a later-described squib 42 of the second gas supply region 40. In this embodiment, specifically, when the control device 53 detects an unavoidable impact before an actual impact by a signal sent from the pre-crash sensor 54, the solenoid 37 is energized in response to a signal from the control device 53 to open the valve body 38. If the valve body 38 is opened, the pressurized gas G0 stored in the gas generating chamber 30 is supplied into the airbag 19 as the inflation gas G1 via the orifice 32a as shown in FIG. 4A.

The second gas supply region 40 is comprised of the orifices 32b disposed around the orifice 32a and communicated with the gas generating chamber 30, sealing members 41 closing off the orifices 32b and a squib 42 disposed inside the gas generating chamber 30. The squib 42 is secured to the central area of the bottom wall 33 and electrically connected with the control device 53 by an unillustrated lead wire. The squib 42 is to be ignited to generate a gas when fed with signals from the control device 53. In this embodiment, the squib 42 is ignited in response to a signal fed from the control device 53 when the control device 53 detects an actual impact by a signal sent from the crash sensor 55. When the squib 42 is ignited, gas is produced to increase the internal pressure inside the gas generating chamber 30. Then the sealing members 41 having sealed off the orifices 32b are broken as shown in FIG. 4B, so that the pressurized gas G0 stored inside the gas generating chamber 30 is fed into the airbag 19 as the inflation gas G2 through the orifices 32b.

The inflator body 28 of this embodiment is designed such that the amount of substance of inflation gas G1 supplied into the airbag 19 per unit time by the first gas supply region 35 is less than the amount of substance of inflation gas G2 supplied into the airbag 19 per unit time by the second gas supply region 40. Specifically, it is designed such that, assuming that the time period from the detection of an unavoidable impact to the detection of an actual impact is about 100 ms (80 to 120 ms), the first gas supply region 35 supplies the inflation gas G1 corresponding to about 1 to 30% of the pressurized gas G0 stored inside the gas generating chamber 30 during the about 100 ms and the second gas supply region 40 supplies the inflation gas G2 corresponding to 30 to 100% of the pressurized gas G0 during about 30 ms (20 to 40 ms) after the detection of an actual impact.

As shown in FIG. 2, the diffuser 46 has a generally circular cylindrical contour so as to cover a region of the inflator body 28 above the flange 44. The diffuser 46 includes a generally cylindrical circumferential wall 47 disposed at a side of the gas generating chamber 30, a generally discoid ceiling wall 48 closing off the top of the circumferential wall 47, and a generally annular flange 49 disposed at the bottom of the circumferential wall 47. The circumferential wall 47 is provided on its generally entire circumference with numerous gas outlet ports 47a allowing the inflation gasses G1 and G2 fed from the inflator body 28 to flow into the airbag 19 therefrom. On top of the ceiling wall 48 is the push-up mechanism 14 as described above.

The inflator 27 is secured to the steering wheel body 1 by bolt 51 fixing the flanges 44 of the inflator body 28 and the flange 49 of the diffuser 46 to the flange 5a of the bracket 5 with the peripheral area 21b of the aperture 21a on the vehicle body side wall 21 of the airbag 19 disposed between the flanges 44 and 49.

If a moving vehicle equipped with the airbag apparatus M1 cracks up, the control device 53 outputs an actuating signal to the inflator 27, so that the airbag 19 inflates with the inflation gasses G1 and G2 and deploys in such a manner as to cover the top side of the steering wheel W as shown in FIGS. 5C and 6C.

In the airbag apparatus M1 according to the first embodiment of the present invention, the inflator 27 has two modes of operation: the rapid discharge mode where it discharges a great amount of inflation gas G2 and the slow discharge mode where the amount of substance of inflation gas G1 supplied into the airbag 19 per unit time is less than in the rapid discharge mode. More specifically, the inflator 27 of the first embodiment has the first gas supply region 35 for supplying the inflation gas G1 in the slow discharge mode, and the second gas supply region 40 for supplying the inflation gas G2 in the rapid discharge mode. If the inflator 27 operates in the slow discharge mode, the inflation gas G1 is gradually fed from the first gas supply region 35 to unfurl the airbag 19. This mode prevents the inflator 27 from feeding a great amount of inflation gas rapidly into the airbag 19 in the initial stage of operation of the inflator 27, and prevents the internal pressure of the airbag 19 from rising excessively in the initial stage of airbag inflation.

Further, the airbag apparatus M1 includes the push-up mechanism 14 between the pad or airbag cover 7 and the diffuser 46 which operates under control of the control device 53 as the opening forming means or the resistance reduction means. The push-up mechanism 14 pushes up the pad 7 when the inflator 27 discharges the inflation gas G1 in the slow discharge mode to provide the opening O1 below the pad 7 so the airbag 19 deploys therefrom. That is, even in the slow discharge mode where the inflation gas G1 is gradually supplied to the airbag 19 by the first gas supply region 35 in the initial stage of airbag inflation, the push-up mechanism 14 operates to provide the opening O1 to allow the airbag to deploy therefrom smoothly while reducing the resistance the airbag would otherwise experience upon protrusion from the housing. Consequently, the airbag 19 smoothly deploys with suppressed internal pressure.

Therefore, in the airbag apparatus M1 of the first embodiment, the internal pressure of the airbag 19 is suppressed from rising excessively in the initial stage of airbag inflation while securing a smooth protrusion of the airbag 19 from the airbag housing P1.

Especially in the first embodiment, the control device 53 is electrically connected with the pre-crash sensor 54 and the crash sensor 55. The control device 53 operates the push-up mechanism 14 and the first gas supply region 35 of the inflator 27 in the slow discharge mode when detecting an unavoidable crash by a signal fed from the pre-crash sensor 54, whereas it operates the second gas supply region 40 of the inflator 27 in the rapid discharge mode when detecting an actual impact by a signal fed from the crash sensor 55. More specifically, when an avoidable impact is sensed by the pre-crash sensor 54, the control device 53 feeds activating signals to the push-up mechanism 14 and the solenoid 37 of the electromagnetic valve 36, which constitutes the first gas supply region 35 of the inflator 27. Then the push-up mechanism 14 pushes up the pad 7 so as to provide the opening O1 below the pad 7 as shown in FIG. 5B, and the airbag 19 deploys from the opening O1 while admitting inflation gas G1 fed from the first gas supply region 35 in the slow discharge mode. When an actual crash is sensed by the crash sensor 55 thereafter, the control device 53 feeds an activating signal to the squib 42 of the second gas supply region 40 to feed the airbag 19 with inflation gas G2 in the rapid discharge mode. Hence the airbag 19 completes inflation as shown in FIG. 5C.

That is, in the airbag apparatus M1, the airbag 19 firstly unfurls from the folded state and protrudes from the housing area P1 for deployment via the opening O1 formed by the lift of the pad 7 in a gradual fashion by inflation gas G1 fed from the first gas supply region 35 in the slow discharge mode. Then the airbag 19 inflates to the full upon the detection of an actual crash by inflation gas G2 supplied from the second gas supply region 40 in the rapid discharge mode where the amount of substance of supply of inflation gas G2 per unit time by the second gas supply region 40 is greater than that by the first gas supply region 35.

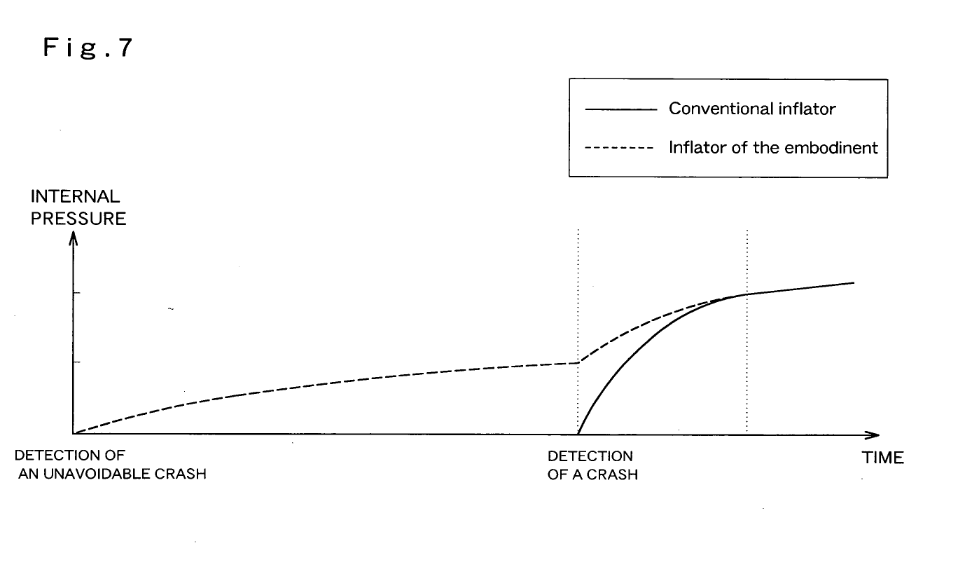

In other words, since the inflation gas G1 is supplied to the airbag 19 gently ahead of the detection of an actual impact, the internal pressure of the airbag 19 rises gently during the time period from the detection of an unavoidable crash to the detection of an actual crash as shown in a graph of FIG. 7. Hence the internal pressure of the airbag 19 is suppressed from rising rapidly during the time period from the detection of an actual crash till the completion of inflation in comparison with an instance where a conventional inflator is used to inflate the airbag upon or after a detection of an actual crash. Therefore, when the airbag apparatus M1 is directed to protect a driver or an occupant during the time period from the detection of a crash to the full inflation of the airbag 19, the airbag 19 does not apply an undue pressure to the driver, and moreover, since the airbag 19 already has an internal pressure of a certain level at the time of the crash, it protects the driver smoothly with an adequate cushioning property. Of course, in the airbag apparatus M1, too, the airbag 19 is kept fully inflated for a certain time period after the completion of inflation in a similar manner to an instance where an airbag starts to be inflated after a detection of a crash.

Further in the first embodiment, the airbag cover or pad 7 includes the doors 9 openable when pushed by the inflating airbag 19. The doors 9 open when pushed by the airbag 19 and form the opening O1 allowing the airbag 19 to deploy therefrom when the second gas supply region 40 operates in the rapid discharge mode upon a crash and the push-up mechanism 14 is inactive. Hence, even in the event that the control device 53 failed to predict a crash by the pre-crash sensor 54, if the doors 9 are pushed and opened by the airbag 19 inflating with inflation gas G2 fed in the rapid discharge mode after an actual impact as shown in FIGS. 6B and 6C, the airbag 19 deploys quickly from the opening O1 provided by the opening of the doors 9. Of course, such doors are not imperative if the above advantage does not have to be considered. It will also be appreciated that the airbag cover does not include a door and the push-up mechanism is alternatively activated upon the detection of an actual crash.

Although the airbag apparatus M1 employs the push-up mechanism 14 as the means to form the opening for the airbag to protrude therefrom for reduction of a resistance, the means to form the opening should not be limited thereby. The opening may be formed such that the pad includes a door on the ceiling wall while the airbag apparatus includes a small bag formed separate from the airbag and housed in the housing to act as the means to form the opening by pushing open the door when fed with inflation gas.

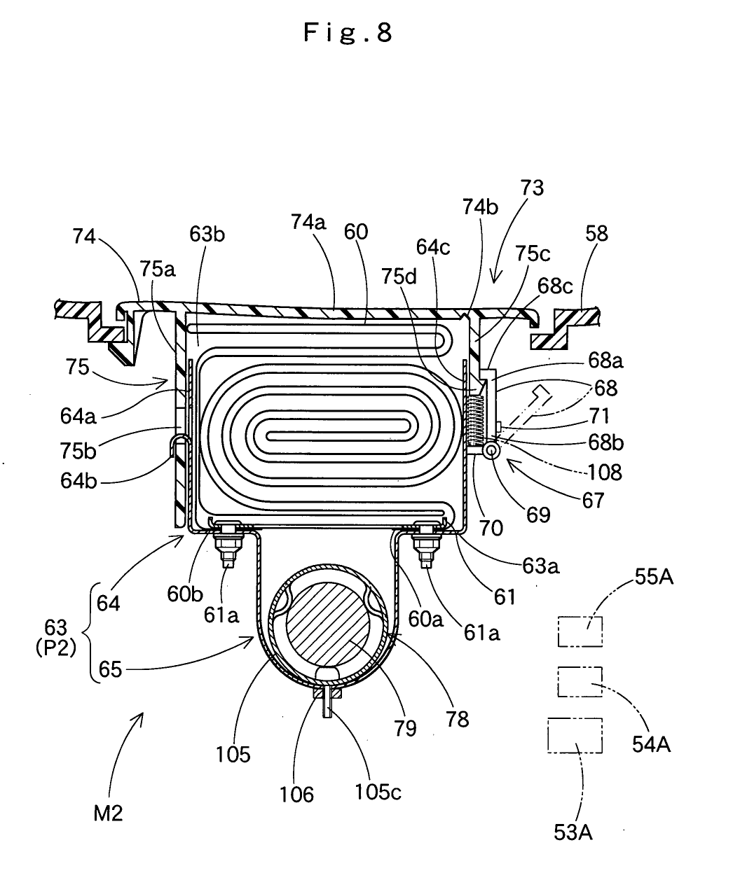

The second embodiment of the present invention is now described. An airbag apparatus M2 according to the second embodiment is of protection of a passenger seated in a front passenger's seat, and is mounted on an instrument panel or dashboard 58 in front of the front passenger's seat as shown in FIG. 8. The airbag apparatus M2 includes a folded airbag 60, an inflator 78 for supply of inflation gas to the airbag 60, a case 63 acting as a housing area P2 housing and holding the airbag 60 and the inflator 78, a retainer 61 for attachment of the airbag 60 to the case 63, an airbag cover 73 covering the folded airbag 60, and a decoupling mechanism 67 acting as decoupling means or resistance reduction means to reduce the resistance the airbag experiences upon projecting from the case 63. In the second embodiment, too, operations of the inflator 78 and the decoupling mechanism 67 are under control of a control device 53A. In a similar manner to the first embodiment, the control device 53A is electrically connected with a pre-crash sensor 54A and a crash sensor 55A, and operates the inflator 78 and the decoupling mechanism 67 in response to electric signals fed from these sensors 54A and 55A.

The airbag 60 has a bag contour including on a lower part an opening 60a for admitting inflation gas. The airbag 60 is fabricated of woven fabric of polyester, polyamide or the like, and is attached at a region 60b around the opening 60a to a later-described flange 63a of the case 63 by the retainer 61 which is formed of sheet metal into a generally square annular contour and have bolts 61a.

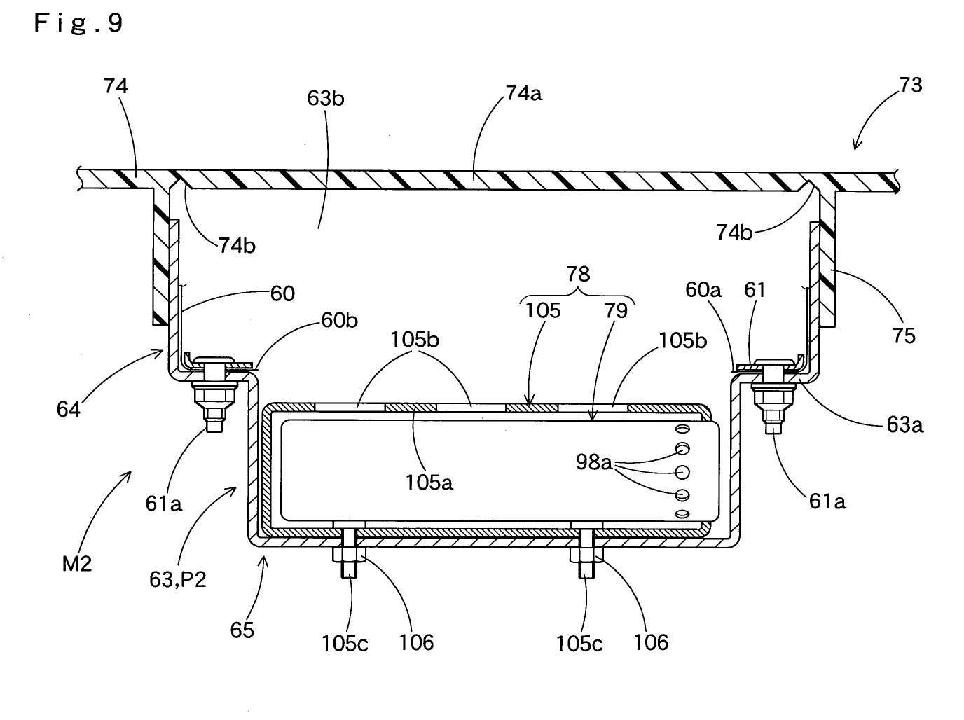

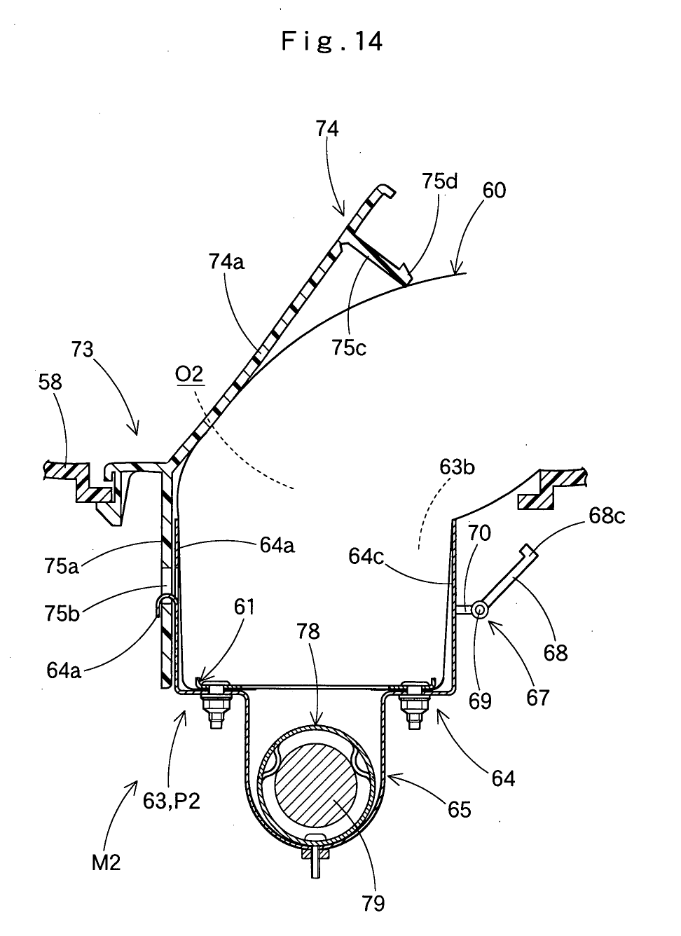

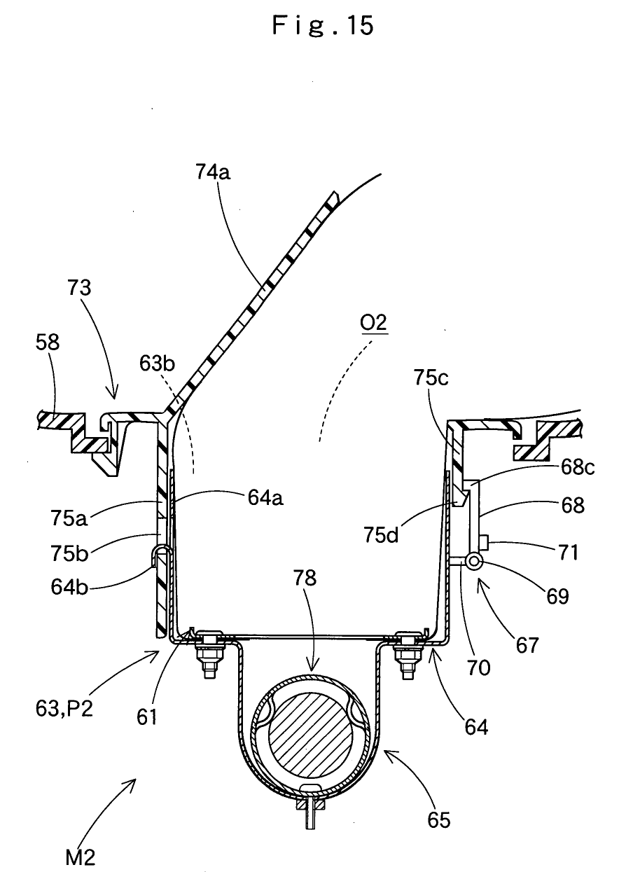

As shown in FIGS. 8 and 9, the case 63 acting as the housing area P2 has a generally box shape with an open top so as to provide an opening O2 (FIGS. 14 and 15) for protrusion of the airbag 60. The case 63 includes an airbag housing area 64 disposed on top and an inflator housing area 65 disposed on bottom and having smaller anteroposterior and lateral dimensions than the airbag housing area 64. Between the housing areas 64 and 65 is a flange 63a extending in four directions from the top of the inflator housing area 65 for attachment of the region 60b of the airbag 60 around the opening 60a thereto utilizing the retainer 61. The front wall 64a of the airbag housing area 64 is provided with hooks 64b disposed along the lateral direction for coupling the front wall 64a and a later-described joint wall 75a of the airbag cover 73. Further, a decoupling mechanism 67 acting as decoupling means is formed on the rear wall 64c of the airbag housing area 64 for retaining a later-described engagement wall 75c of the airbag cover 73 in a disengageable manner.

Referring to FIG. 8, the decoupling mechanism 67 acting as the decoupling means and further as the resistance reduction means includes a retaining pin 68 for engagement with the engagement wall 75c, a pivot portion 69 pivotally supporting the retaining pin 68 at the root region 68b, and a holding member 71 for keeping the retaining pin 68 engaged with the engagement wall 75c. The retaining pin 68 includes a projection 68c at the leading end area 68a, which projection 68c projecting forward toward the engagement wall 75c. The retaining pin 68 is engaged with the engagement wall 75c by mutual fit of the projection 68c with a projection 75d formed at the lower end of the engagement wall 75c. The pivot portion 69 is disposed at the leading end of a mounting member 70 formed on the rear wall 64c of the case 63 in a rearward protruding manner. The retaining pin 68 is coupled to the pivot portion 69 by an unillustrated spring that urges the pin 68 toward the disengaging direction. The holding member 71 is configured for holding the retaining pin 68 in order to keep the pin 68 engaged with the engagement wall 75c, and stops holding the pin 68 when moved by an unillustrated drive mechanism such as an electromagnetic solenoid operating under control of the control device 53A. In this embodiment, the holding member 71 is designed to stop holding the retaining pin 68 in response to a signal from the control device 53A generally simultaneously with the operation of a later-described first gas supply region 85 of the inflator 78 when the control device 53A detects an unavoidable impact by a signal from the pre-crash sensor 54A. If the holding member 71 stops holding the retaining pin 68, the projection 68c of the retaining pin 68 and the projection 75d of the engagement wall 75c are disengaged from each other, thereby decoupling the airbag cover 73 from the case 63.

The airbag cover 73 is made from synthetic resin such as thermo-plastic elastomer of olefin, styrene or the like, and includes a ceiling wall 74 for covering an opening 63b formed on top of the case 63 and a side wall 75 extending downward from the ceiling wall 74 in a generally square cylindrical fashion. In a region of the ceiling wall 74 surrounded by the side wall 75 is a door 74a with a thinned breakable portion 74b disposed around the door 74a except the front edge. The door 74a is openable when pushed by the airbag 60 fed with inflation gas G5 from a later-described second gas supply region 96 of the inflator 78 when the decoupling mechanism 67 is inactive. In this specific embodiment, at opening, the door 74a turns around its front edge and opens forward after breaking the breakable portion 74b. The part of the side wall 75 disposed in front of the front wall 64a of the airbag housing area 64 acts as the joint wall 75a joined with the front wall 64a by insertion of the hooks 64b of the front wall 64a into holes 75b of the joint wall 75a. The part of the side wall 75 disposed at the rear of the rear wall 64c of the airbag housing area 64 acts as the engagement wall 75c having at the bottom the projection 75d projecting rearward to be engaged with the projection 68c of the retaining pin 68.

As shown in FIG. 9, the inflator 78 includes a generally columnar inflator body 79 and a generally tubular diffuser 105 mounted around the inflator body 79. The inflator 78 has two modes of operation: a rapid discharge mode where it discharges a great amount of inflation gas G5 and a slow discharge mode where the amount of substance of inflation gas G4 supplied into the airbag 60 per unit time is less than in the rapid discharge mode.

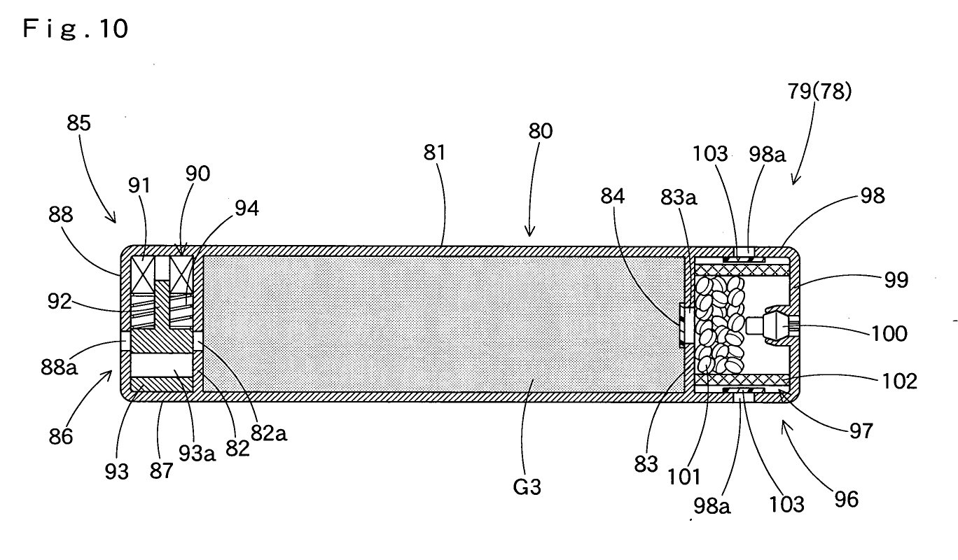

Referring to FIG. 10, the inflator body 79 includes a gas generating chamber 80 filled up with a pressurized gas G3, which is a compressed gas for inflating the airbag, and two gas supply regions supplying the airbag 60 with inflation gas: a first gas supply region 85 supplying inflation gas G4 in the slow discharge mode and a second gas supply region 96 supplying inflation gas G5 in the rapid discharge mode. The first gas supply region 85 and the second gas supply region 96 are disposed at opposite axial ends of the gas generating chamber 80.

As shown in FIG. 10, the gas generating chamber 80 is defined by a circumferential wall 81 having a generally tubular shape and generally circular partitioning walls 82 and 83 disposed in such a manner as to close off opposite axial ends of the circumferential wall 81. The gas generating chamber 80 contains pressurized gas G3 such as nitrogen gas, helium gas, argon gas, or mixed gas of those gasses. The partitioning walls 82 and 83 are each provided with an orifice 82a and 83a which provide communication with the first gas supply region 85 and second gas supply region 96. The orifice 83a formed adjacent the second gas supply region 96 is sealed off by a sealing member 84 from the interior of the gas generating chamber 80. In this embodiment, the orifice 83a communicating the gas generating chamber 80 and the second gas supply region 96 has a greater opening area than that of the orifice 82a communicating the gas generating chamber 80 and the first gas supply region 85.

The first gas supply region 85 has a first gas channel 86 in communication with the gas generating chamber 80 and an electromagnetic valve 90 used to open or close the first gas channel 86. The first gas channel 86 includes a cylindrical circumferential wall 87 extending from the circumferential wall 81 of the gas generating chamber 80 in an integrated fashion and an end wall 88 provided with an aperture 88a which provides a partial opening on a leading end region of the circumferential wall 87. The aperture 88a is formed at a position corresponding to the orifice 82a of the partitioning wall 82 in the axial direction of the inflator body 79.

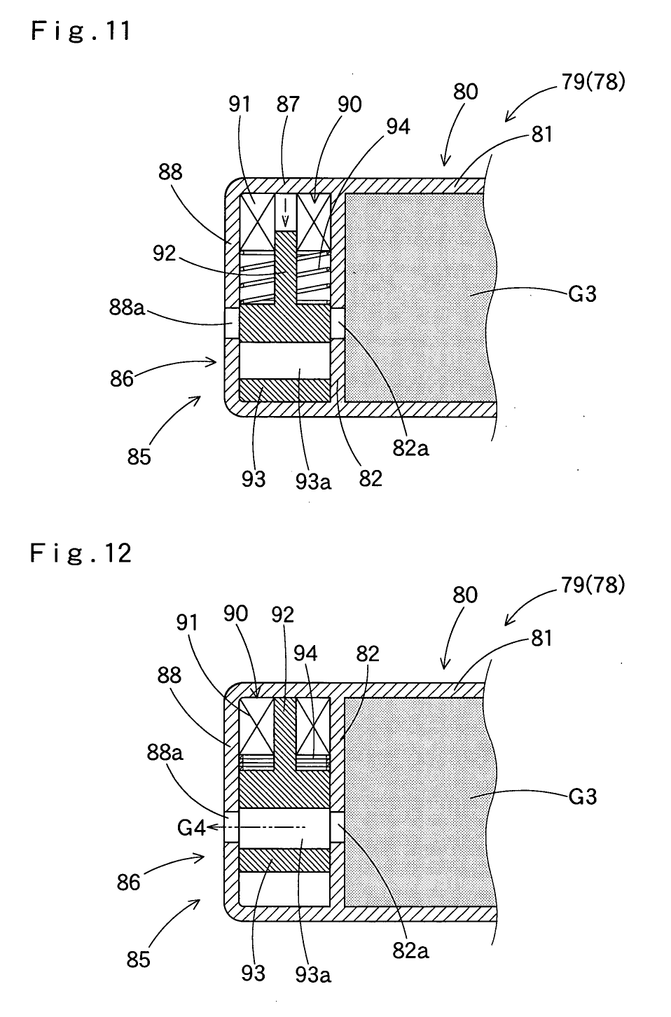

As shown in FIG. 11, the electromagnetic valve 90 is disposed inside the first gas channel 86, and includes a solenoid 91, a plunger 92 provided with a valve body 93 and a coil spring 94 disposed between the valve body 93 and the solenoid 91 to urge the valve body 93 towards the closing direction. The valve body 93 is formed at the leading end of the plunger 92, and includes a through hole 93a formed through the valve body 93 along the axial direction of the inflator body 79. When the solenoid 91 is de-energized, the valve body 93 is urged by the coil spring 94 towards the closing direction and closes off the orifice 82a of the partitioning wall 82 as shown in FIG. 11. When the solenoid 91 is energized, the valve body 93 is opened, i.e. shifts towards the solenoid 91 so that the through hole 93a becomes communicated with the orifice 82a and aperture 88a as shown in FIG. 12. The solenoid 91 is electrically connected with the control device 53A and is designed to operate in advance of the operation of a later-described squib 100 of the second gas supply region 96. In this embodiment, specifically, when the control device 53A detects an unavoidable impact before an actual impact by signals sent from the pre-crash sensor 54A, the solenoid 91 is energized in response to a signal from the control device 53A to open the valve body 93. If the valve body 93 is opened, the pressurized gas G3 stored in the gas generating chamber 80 is supplied into the airbag 60 as the inflation gas G4 via the aperture 88a communicated with the through hole 93a and the orifice 82a.

Back to FIG. 10, the second gas supply region 96 includes a second gas channel 97 and a squib 100 disposed inside the gas channel 97. The second gas channel 97 includes a cylindrical circumferential wall 98 extending from the circumferential wall 81 of the gas generating chamber 80 in an integrated fashion and an end wall 99 closing off the leading end of the circumferential wall 98. The circumferential wall 98 is provided with a plurality of apertures 98a disposed along the circumference. Each of the apertures 98a is sealed off from the interior by a sealing member 103 permeable by inflation gas.

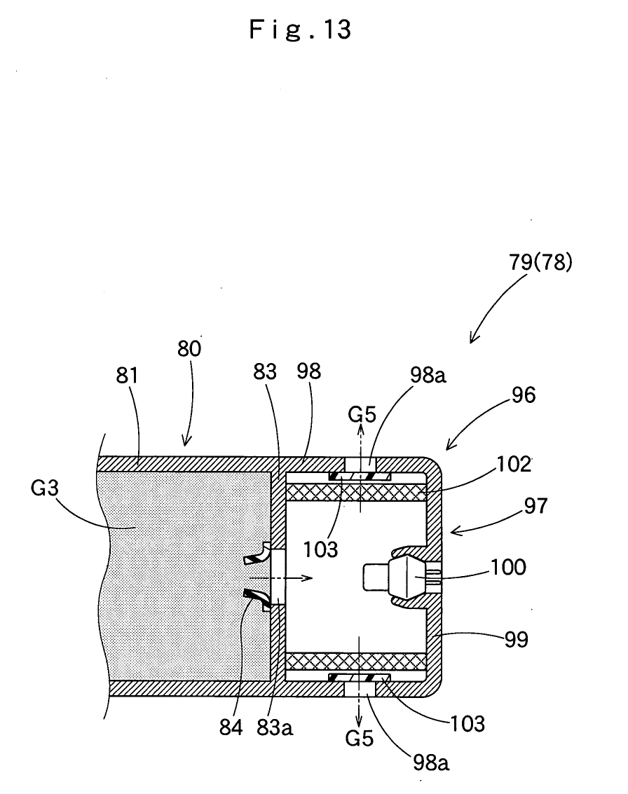

The squib 100 is secured at a substantial center of the end wall 99, and is electrically connected with the control device 53A by an unillustrated lead wire. The squib 100 is to be ignited to generate a gas when fed with a signal from the control device 53A. In this embodiment, a cylindrical filter 102 formed of a wire mesh is arranged along the inner circumference of the circumferential wall 98, and gas generant 101 are stored inside the filter 102 for combustion upon the ignition of the squib 100 to produce inflation gas. The filter 102 cools the inflation gas and catches slag resulting from the combustion of the gas generant 101. In this embodiment, the squib 100 is ignited in response to a signal fed from the control device 53A when the control device 53A detects an actual impact by signals sent from the crash sensor 55A. When the squib 100 is ignited to combust the gas generant 101, gas is produced to increase the internal pressure inside the second gas channel 97. Then the sealing member 84 having sealed off the orifice 83a formed on the partitioning wall 83 of the gas generating chamber 80 is broken as shown in FIG. 13, so that the pressurized gas G3 stored inside the gas generating chamber 80 flows into the second gas channel 97 via the orifice 83a, and then the pressurized gas G3 together with the gas produced by the combustion of the gas generant 101 inside the second gas channel 97 are fed into the airbag 60 as inflation gas G5 through the apertures 98a on the circumferential wall 98.

The inflator body 79 of the second embodiment is also designed such that the amount of substance of inflation gas G4 supplied into the airbag 60 per unit time by the first gas supply region 85 is less than the amount of substance of inflation gas G5 supplied into the airbag 60 per unit time by the second gas supply region 96. Specifically, it is designed such that, assuming that the time period from the detection of an unavoidable impact to the detection of an actual impact is about 100 ms (80 to 120 ms), the first gas supply region 85 supplies the inflation gas G4 corresponding to about 1 to 30% of the pressurized gas G3 stored inside the gas generating chamber 80 during the about 100 ms and the second gas supply region 96 supplies the inflation gas G5 corresponding to 30 to 100% of the pressurized gas G3 during about 30 ms (20 to 40 ms) after the detection of an actual impact.

The diffuser 105 includes, as shown in FIG. 9, a holder region 105a having a generally cylindrical shape to cover the inflator body 79 and a plurality of (two, in this specific embodiment) bolts 105c projected from the holder region 105a. The holder region 105a is provided, on its top side as it is mounted on a vehicle, with gas outlet ports 105b letting out the inflation gasses G4 and G5 emitted from the inflator body 79 into the airbag 60. The inflator 78 is attached to the case 63 by the bolts 105c of the diffuser 105 put through an inflator housing area 65 of the case 63 for nut 106 fastening.

In the airbag apparatus M2 of the second embodiment, too, the inflator 78 has two modes of operation: the rapid discharge mode where it discharges a great amount of inflation gas G5 and the slow discharge mode where the amount of substance of inflation gas G4 supplied into the airbag 60 per unit time is less than in the rapid discharge mode. More specifically, the inflator 78 of the second embodiment has the first gas supply region 85 for supplying the inflation gas G4 in the slow discharge mode, and the second gas supply region 96 for supplying the inflation gas G5 in the rapid discharge mode. If the inflator 78 operates in the slow discharge mode, the inflation gas G4 is gradually fed from the first gas supply region 85 to unfurl the airbag 60. This mode prevents the inflator 78 from feeding a great amount of inflation gas rapidly into the airbag 60 in the initial stage of operation of the inflator 78, and prevents the internal pressure of the airbag 60 from rising excessively in the initial stage of airbag inflation.

Further, the airbag apparatus M2 also includes the decoupling mechanism 67 between the airbag cover 73 and the case 63 which acts under control of the control device 53A as the decoupling means and further as the resistance reduction means. The decoupling mechanism 67 decouples the retaining pin 68 from the engagement wall 75c when the inflator 78 discharges inflation gas G4 in the slow discharge mode so that the airbag cover 73 is separated from the case 63 or the housing area P2. With this structure, even if the mode of discharging inflation gas G4 of the inflator 78 is set slow, the opening 02 for protrusion of the airbag 60 is formed if the airbag cover 73 decoupled from the case 63 by the decoupling mechanism 67 is pushed up by the airbag 60 fed with inflation gas G4 (FIGS. 14 and 15). Accordingly, the airbag 60 is allowed to protrude from the opening O2 thus formed smoothly without experiencing a great resistance, and smoothly unfurls with suppressed internal pressure.

Therefore, in the airbag apparatus M2 of the second embodiment, too, the internal pressure of the airbag 60 is suppressed in the initial stage of airbag inflation while securing a smooth protrusion of the airbag 60 from the airbag housing P2 or the case 63.

Further in the second embodiment, too, the control device 53A is electrically connected with the pre-crash sensor 54A and the crash sensor 55A. The control device 53A activates the decoupling mechanism 67 and the first gas supply region 85 of the inflator 78 in the slow discharge mode when detecting an unavoidable crash by a signal fed from the pre-crash sensor 54A, whereas it activates the second gas supply region 96 of the inflator 78 in the rapid discharge mode when detecting an actual impact by a signal fed from the crash sensor 55A. More specifically, when an avoidable impact is sensed by the pre-crash sensor 54A, the control device 53A feeds activating signals to the decoupling mechanism 67 and the solenoid 91 of the electromagnetic valve 90, which constitutes the first gas supply region 85 of the inflator 78. Then the decoupling mechanism 67 operates to dissolve the engagement between the case 63 and the airbag cover 73 so that the airbag cover 73 is pushed up by the inflating airbag 60, thereby forming the opening O2 as shown in FIG. 14, and allowing the airbag 60 to deploy therefrom while admitting inflation gas G4 fed from the first gas supply region 85 in the slow discharge mode. When an actual crash is sensed by the crash sensor 55A thereafter, the control device 53A feeds an activating signal to the squib 100 of the second gas supply region 96 to feed the airbag 60 with inflation gas G5 in the rapid discharge mode, so that the airbag 60 inflates to the full.

That is, in the airbag apparatus M2, the airbag cover 73 decoupled from the case 63 by the activation of the decoupling mechanism 67 is pushed up by the inflating airbag 60 so the opening O2 is formed below the airbag cover 73, and then the airbag 60 unfurls from the folded state and protrudes from the case 63 or housing area P2 for deployment via the opening O2 in a gradual fashion by inflation gas G4 fed from the first gas supply region 85 in the slow discharge mode. Since the engagement of the case 63 and the airbag cover 73 has been dissolved before airbag inflation, the resistance the airbag 60 would experience upon protrusion is reduced so that the airbag 60 pushes up the airbag cover 73 easily to provide the opening 02 even when inflation gas G4 is fed to the airbag 60 gently in the initial stage of inflation. Thereafter, the airbag 60 inflates to the full upon the detection of an actual crash by inflation gas G5 supplied from the second gas supply region 96 in the rapid discharge mode where the amount of substance of supply of inflation gas G5 per unit time by the second gas supply region 96 is greater than that by the first gas supply region 85.

In other words, in a similar manner to the first embodiment, since the inflation gas G4 is supplied to the airbag 60 gently ahead of the detection of an actual impact, the internal pressure of the airbag 60 rises gently during the time period from the detection of an unavoidable crash to the detection of an actual crash. Hence the internal pressure of the airbag 60 is suppressed from increasing rapidly during the time period from the detection of an actual crash to the completion of inflation in comparison with an instance where a conventional inflator is used to inflate the airbag after the detection of an actual crash. Therefore, when the airbag apparatus M2 is directed to protect an occupant seated in the front passenger's seat during the time period from the detection of a crash to the full inflation of the airbag 60, the airbag 60 does not apply an undue pressure to the occupant, and moreover, since the airbag 60 already has an internal pressure of a certain level at the time of the crash, it protects the occupant smoothly with an adequate cushioning property. Of course, in the airbag apparatus M2, too, the airbag 60 is kept fully inflated for a certain time period after the completion of inflation in a similar manner to an instance where an airbag starts to be inflated after a detection of a crash.

Further in the second embodiment, too, the airbag cover 73 includes the door 74a openable when pushed by the inflating airbag 60. The door 74a opens when pushed by the airbag 60 and forms the opening O2 allowing the airbag 60 to deploy therefrom when the second gas supply region 96 operates in the rapid discharge mode upon a crash and the decoupling mechanism 67 is inactive. Hence, even in the event that the control device 53A failed to predict a potential crash by the pre-crash sensor 54A, if the door 74a is pushed and opened by the airbag 60 inflating with inflation gas G5 fed from the second gas supply region 96 in the rapid discharge mode after an actual impact as shown in FIG. 15, the airbag 60 deploys quickly from the opening O2 provided by the opening of the door 74a. Of course, such door is not imperative if the above advantage does not have to be considered, but alternatively it will be appreciated to activate the decoupling mechanism upon the detection of an actual crash.

The decoupling mechanism 67 of the second embodiment acting as the decoupling means to reduce the resistance is designed to decouple the airbag cover 73 from the case 63 by simply dissolving the engagement between the retaining pin 68 and the engagement wall 75c. It will also be appreciated to locate a compression coil spring 108 between the mounting member 70 and the engagement wall 75c as indicated by phantom lines in FIG. 8 so that the airbag cover 73 is pushed up toward the opening direction by the biasing force of the spring 108 upon the operation of the decoupling mechanism 67 for further reduction of the resistance upon airbag protrusion.

Moreover, the inflator bodies 28 and 79 of the foregoing embodiments include a single gas generating chamber 30/80 and two gas supply regions 35/85 and 40/96 both of which are communicated with the gas generating chamber 30/80, which simplifies the structure of the inflator 27/78. Of course, the inflator may be designed to include two gas generating chambers so each of them is communicated with the first or second gas supply region if the above advantage does not have to be considered. Further, it maybe designed with a single gas supply region whose amount of supply of inflation gas is variable.

Although the foregoing embodiments have been described as applied to airbag apparatuses for a steering wheel (first embodiment) and for a front passenger's seat (second embodiment), the application of the present invention should not be limited thereby. The present invention can also be applied to airbag apparatuses for head-protection, knee-protection, pedestrian protection, and a side-impact airbag apparatus.

What is claimed is:

1. An airbag apparatus comprising:
an airbag folded and housed in a housing;
an inflator for supplying inflation gas to the airbag under control of a control device, the inflator having two modes of operation; a rapid discharge mode where the inflator discharges a great amount of inflation gas and a slow discharge mode where the amount of substance of inflation gas supplied into the airbag per unit time is less than in the rapid discharge mode;
an airbag cover disposed to cover the housing; and
resistance reduction means operable under control of the control device for reducing a resistance which the airbag encounters upon protrusion from the housing to assist the airbag with protrusion from the housing when the inflator operates in the slow discharge mode.

2. The airbag apparatus of claim 1, wherein the resistance reduction means is comprised of opening forming means to form an opening allowing the airbag to protrude therefrom by moving at least part of the airbag cover.

3. The airbag apparatus of claim 1, wherein the resistance reduction means is comprised of decoupling means to decouple the airbag cover from the housing such that the airbag cover is allowed to open pushed by the airbag in process of inflation.

4. The airbag apparatus of claim 1, wherein:
the control device is electrically connected with a pre-crash sensor and a crash sensor;
the control device activates the resistance reduction means together with the inflator in the slow discharge mode when sensing an unavoidable crash by a signal fed from the pre-crash sensor; and
the control device activates the inflator in the rapid discharge mode when sensing an actual impact by a signal fed from the crash sensor.

5. The airbag apparatus of claim 4, wherein the airbag cover comprises a door pushed open by the airbag in process of inflation for forming an opening allowing the airbag to protrude therefrom when the inflator operates in the rapid discharge mode upon a crash and the resistance reduction means is inactive.

6. The airbag apparatus of claim 1, wherein:
the inflator comprises:
a gas generating chamber filled up with a pressurized gas, which gas is a compressed gas for inflating the airbag;
a first gas supply region for supplying inflation gas in the slow discharge mode, the first gas supply region including a first gas channel communicated with the gas generating chamber and a valve mechanism for opening and closing the first gas channel; and
a second gas supply region for supplying inflation gas in the rapid discharge mode, the second gas supply region including a second gas channel communicated with the gas generating chamber, a sealing member sealing off the second gas channel, and a squib disposed inside the gas generating chamber for ignition to generate a gas, wherein a rise of an internal pressure of the gas generating chamber upon ignition of the squib helps to break the sealing member to open.
